(19) United States
(12) Patent Application Publication
(10) Pub. No.: US 2026/0078632 A1
(43) Pub. Date: Mar. 19, 2026

(54) HOLLOW CORE DOOR WITH ENHANCED ACOUSTIC PERFORMANCE

(71) Applicant: Masonite Corporation, Tampa, FL (US)

(72) Inventors: Michael FUQUA, Chicago, IL (US); Steven SWARTZMILLER, Batavia, IL (US)

(21) Appl. No.: 19/332,595

(22) Filed: Sep. 18, 2025

Related U.S. Application Data
(60) Provisional application No. 63/696,227, filed on Sep. 18, 2024.

(51) Int. Cl. E06B 3/70

(52) U.S. Cl. CPC E06B 3/7015; E06B 2003/7019; E06B 2003/7023; E06B 2003/7025; E06B 2003/7032; E06B 2003/7049

(57) ABSTRACT

The present disclosure provides an acoustic hollow core door comprising a door slab including an inner door frame, a first facing secured to a first side of the inner door frame, and a second facing secured to a second, opposite side of the inner door frame. The inner door frame and the first and second facings define an at least partially hollow air cavity, and at least one of the first or second facings has a thickness between about 0.150 and 0.320 inches and a nominal density of between about 0.80 and 1.1 grams per cubic centimeter. The hollow core door may include internal sticks or core inserts positioned within the hollow air cavity between the first and second facings. Acoustically absorptive material may be positioned within the hollow air cavity to reduce resonance effects around 250-315 Hz frequency range. The acoustic hollow core door achieves STC ratings of between about 25 and 31, while maintaining weight reduction compared to solid core doors with comparable acoustic performance.

### CROSS-REFERENCE TO RELATED APPLICATIONS

This application claims priority to U.S. Provisional Application No. 63/696,227, filed Sep. 18, 2024, the disclosure of which is hereby incorporated by reference in its entirety.

### FIELD OF INVENTION

The present disclosure relates to doors for residential or commercial buildings, and more particularly to hollow core doors with enhanced acoustic performance achieved through increased facing thickness and optimized internal configurations that leverage the double wall phenomenon while maintaining reduced weight compared to solid core alternatives.

### BACKGROUND

Doors for residential and commercial buildings serve multiple functions, including providing security, privacy, and acoustic control. Among these functions, acoustic control has become increasingly important as building occupants increasingly seek to minimize sound transmission between rooms and/or other building spaces. Traditional door construction approaches have relied primarily on solid core materials to achieve acoustic performance, but these solutions present significant limitations in terms of weight, cost, and manufacturing complexity.

Solid core doors typically achieve acoustic performance through mass-based sound transmission reduction, requiring dense materials such as particleboard, medium density fiberboard, or other composite materials to fill the entire internal cavity between door facings. While this approach can provide improved Sound Transmission Class (STC) ratings, solid core door construction results in substantially increased door weight, often ranging from 60 to 75 pounds for standard residential door sizes. The increased weight creates handling difficulties during manufacturing, transportation, and installation, leading to safety challenges and increased labor costs throughout the distribution chain.

Conventional hollow core doors offer weight and cost advantages compared to solid core alternatives, but suffer from poor acoustic performance characteristics. Standard hollow core construction utilizes thin door facings, typically around 0.125 inches thick, separated by minimal internal elements such as cardboard spacers or expanded polystyrene components. These configurations results in STC ratings typically around 25, which proves inadequate for applications requiring sound transmission control. The lightweight construction and minimal internal mass provide insufficient acoustic impedance to prevent sound transmission between spaces.

Current approaches to improving hollow core door acoustic performance have focused primarily on increasing internal mass through solid core materials or adding more numerous internal elements. However, these approaches compromise the fundamental weight and cost advantages that make hollow core construction attractive while failing to achieve significant improvements to acoustic performance. Additionally, conventional hollow core doors require numerous internal support elements to prevent facing distortion, creating mechanical coupling points that can reduce acoustic performance by allowing direct vibrational energy transfer between opposing door facings.

Manufacturing processes for acoustic doors also present challenges in terms of complexity, material costs, and production efficiency. Solid core doors require precise machining and shaping of core materials to accommodate panel configurations and facing contours, limiting manufacturing flexibility and increasing production costs. In addition, the handling requirements associated with heavy solid core materials create safety concerns and reduce manufacturing productivity compared to lighter hollow core alternatives.

Accordingly, there is a need for a new type of hollow core door that achieves acoustic performance comparable to solid core doors, while also maintaining the weight and cost advantages of hollow core design.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an acoustic hollow core door is provided. The acoustic hollow core door comprises a door slab including an inner door frame. The door further includes a first facing secured to a first side of the inner door frame and a second facing secured to a second, opposite side of the inner door frame. The inner door frame and the first and second facings define an at least partially hollow air cavity, and at least one of the first facing or the second facing has a thickness between about 0.150 and 0.320 inches and a nominal density of between about 0.80 and 1.1 grams per cubic centimeter.

According to other aspects of the present disclosure, the acoustic hollow core door may include one or more of the following features. Both the first facing and the second facing may have a thickness between about 0.150 and 0.320 inches and a nominal density of between about 0.80 and 1.1 grams per cubic centimeter. At least one of the first facing and the second facing may comprise a double facing arrangement with multiple layers adhered together. The first facing and the second facing may have 25% to 110% more mass than facings of a standard hollow core door. The first facing and the second facing may be formed from materials selected from the group consisting of wood composite, hardboard, medium density fiberboard, oriented strand board, wood-plastic composites, sheet molding compounds containing thermosetting polymer and fiberglass, fiberglass-reinforced thermoplastic, steel, and combinations thereof. The door slab may have 17% to 125% more mass than a door slab of a standard hollow core door. The door may further comprise one or more internal sticks or core inserts positioned within the hollow air cavity between the first and second facings. The one or more internal sticks or core inserts may comprise materials selected from the group consisting of paperboard, wood, expanded polystyrene foam, viscoelastic foam, cork, rigid fiber board, corrugated paper, oriented strand board, wheatstraw blocks, and combinations thereof. The door may further comprise at least one acoustically absorptive material positioned within the hollow air cavity between the first and second facings. The acoustically absorptive material may comprise materials selected from the group consisting of fiberglass, cotton batting, mineral wool, viscoelastic open cell foam, and combinations thereof. The acoustically absorptive material may be positioned in plural recesses of the first and second facings within the hollow air cavity and may be configured to reduce resonance effects around 250-315 Hz frequency range.

According to another aspect of the present disclosure, a method of manufacturing an acoustic hollow core door is provided. The method comprises securing a first facing to a first side of an inner door frame, securing one or more internal support elements within a hollow air cavity defined by the inner door frame, and securing a second facing to a second, opposite side of the inner door frame. At least one of the first facing or the second facing has a thickness between about 0.150 and 0.320 inches and a nominal density of between about 0.80 and 1.1 grams per cubic centimeter to provide enhanced acoustic performance through a double wall phenomenon.

According to other aspects of the present disclosure, the method may include one or more of the following features. Both the first facing and the second facing may have a thickness between about 0.150 and 0.320 inches and a nominal density of between about 0.80 and 1.1 grams per cubic centimeter. The one or more internal support elements may comprise materials selected from the group consisting of paperboard, wood, expanded polystyrene foam, viscoelastic foam, cork, rigid fiber board, corrugated paper, oriented strand board, wheatstraw blocks, and combinations thereof. The method may further comprise a step of positioning at least one acoustically absorptive material within the hollow air cavity between the first and second facings. The acoustically absorptive material may comprise materials selected from the group consisting of fiberglass, cotton batting, mineral wool, viscoelastic open cell foam, and combinations thereof. The step of positioning the acoustically absorptive material may reduce resonance effects occurring in around the 250-315 Hz frequency range. The one or more internal support elements may be spaced to reduce mechanical coupling between the first and second facings and enhance the double wall phenomenon. The internal support elements may comprise one or more internal sticks or core inserts configured to enhanced structural stiffness provided by the thickness of at least one of the first facing or the second facing. The acoustic hollow core door may achieve a Sound Transmission Class rating between 25 and 31 while maintaining a weight reduction of 17% to 53% compared to at least one solid core doors with comparable acoustic performance.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a perspective view of a partially assembled hollow core door assembly, according to aspects of the present disclosure.

FIG. 1B illustrates a perspective view of the partially assembled hollow core door assembly of FIG. 1A with core inserts, according to aspects of the present disclosure.

FIG. 2 illustrates a perspective view of a hollow core door with cork pucks, according to aspects of the present disclosure.

FIG. 3 illustrates a perspective view of a hollow core door with oriented strand board spacers, according to aspects of the present disclosure.

FIG. 4 illustrates a graph showing acoustic transmission loss curves for various door configurations, according to aspects of the present disclosure.

FIG. 5 illustrates a graph showing acoustic transmission loss curves for different door configurations, according to aspects of the present disclosure.

FIG. 6 illustrates a graph showing acoustic transmission loss based on varying facing thicknesses, according to aspects of the present disclosure.

FIG. 7 illustrates a graph showing acoustic transmission loss for various hollow core door configurations, according to aspects of the present disclosure.

FIG. 8 illustrates a perspective view of a hollow core door with wheatstraw blocks, according to aspects of the present disclosure.

FIG. 9 illustrates a graph showing acoustic transmission loss for door configurations with insulation, according to aspects of the present disclosure.

FIG. 10A illustrates a perspective view of a hollow core door with internal sticks, according to aspects of the present disclosure.

FIG. 10B illustrates a top view of the hollow core door of FIG. 10A with insulation, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

This disclosure relates to systems and methods for hollow core door construction that utilizes increased facing thickness and optimized internal configurations to achieve improved acoustic performance while reducing weight and cost compared to traditional solid core doors. The disclosed approaches leverage the double wall phenomenon (further explained below) through strategic placement of internal support elements and absorptive materials, allowing hollow core doors to match or exceed the sound transmission class ratings of conventional solid core doors at significantly lower overall weight. In some cases, the systems incorporate thicker door facings with densities between about 0.80 and 1.1 grams per cubic centimeter, which may provide enhanced structural stiffness that reduces the number of internal support elements needed while maintaining door integrity. The methods may include selective placement of absorptive materials such as fiberglass, cotton batting, mineral wool, viscoelastic open cell foam, and/or other materials or combinations within internal cavities to dampen resonance effects and further enhance acoustic performance. These hollow core door solutions offer an alternative that combines superior acoustic properties with reduced material costs, lighter weight for easier installation and handling, and simplified manufacturing processes compared to traditional solid core acoustic doors.

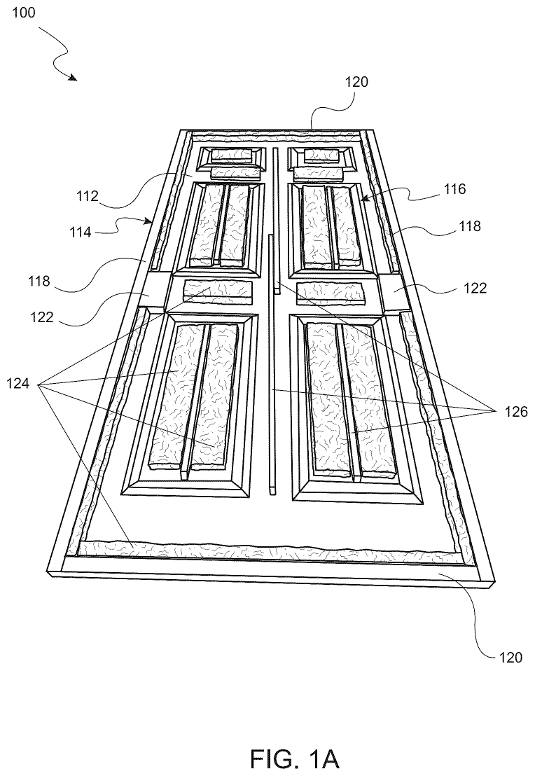

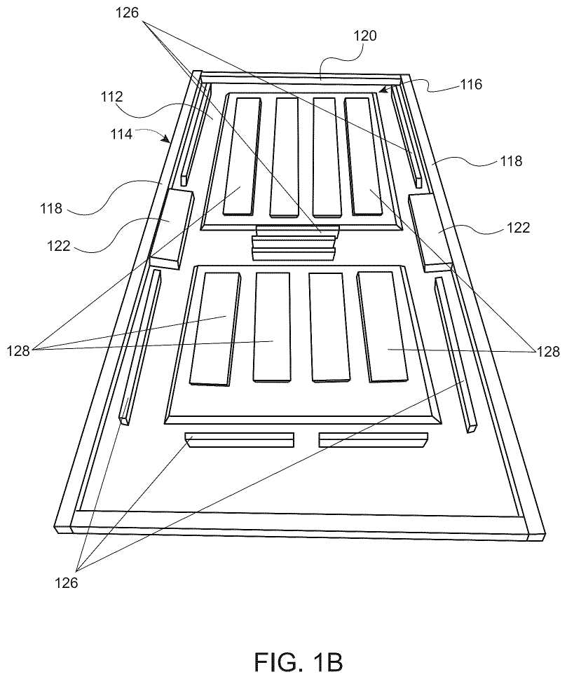

Referring to FIG. 1A, a hollow core door assembly 100 is shown comprising a peripheral frame 114 that forms the structural foundation of the door. The peripheral frame 114 can be constructed from wood, metal, composite materials such as medium density fiberboard (MDF), or combinations of these materials. A first door facing 112 can be secured to a first side of the peripheral frame 114, while a second door facing (not shown in FIG. 1A) can be secured to an opposite side of the peripheral frame 114. The first door facing 112 and the second door facing can be formed from wood composite, hardboard, medium density fiberboard (MDF), oriented strand board, wood-plastic composites, sheet molding compounds (SMCs) containing thermosetting polymer and fiberglass, fiberglass-reinforced thermoplastic, steel, or other materials or combinations. The door facings can be secured to the peripheral frame 114 using adhesive, mechanical fasteners, or a combination thereof to create a unified door structure.

The peripheral frame 114 in this example includes vertical stiles 118 and horizontal rails 120 that define the outer boundaries and internal structure of the hollow core door assembly 100. In some cases, the peripheral frame 114 can include intermediate rails extending between and parallel to the top and bottom rails 120, creating additional structural divisions within the door assembly. The stiles 118 and rails 120 work together to create a grid-like framework that divides the space between the door facings into multiple compartments. This arrangement forms an internal cavity 116 that extends throughout the interior space of the hollow core door assembly 100, with the internal cavity 116 being bounded by the first door facing 112, the second door facing, and the peripheral frame 114 components.

With continued reference to FIG. 1A, one or more lock blocks 122 can be positioned within the peripheral frame 114 structure. The lock blocks 122 can be strategically located adjacent to the stiles 118 where door hardware such as handles, locks, hinges, etc. will be mounted. These lock blocks 122 provide reinforced mounting points for hardware attachment while maintaining the overall hollow core configuration of the door assembly 100. The positioning of the lock blocks 122 within the peripheral frame 114 allows for secure hardware installation without compromising the acoustic properties of the internal cavity 116.

The internal cavity 116 configuration created by the arrangement of the stiles 118, rails 120, and door facings provides the foundation for the acoustic performance characteristics of the hollow core door assembly 100. The compartmentalized nature of the internal cavity 116, formed by the intersecting stiles 118 and rails 120, creates multiple air spaces that may disrupt sound wave transmission through the door structure. As shown in FIGS. 1A and 1B, the internal cavity 116 can accommodate various internal components while maintaining the hollow core design that enables the double wall phenomenon. Depending on the particular use case, the hollow core door assembly 100 can be configured as a six panel door, a two panel door, or a door with a different number of panels, each of which includes the internal cavity 116 structure adapting to accommodate the specific panel configuration.

The double wall phenomenon mentioned above occurs when sound transmission encounters two parallel barriers separated by an air gap, creating a mass-air-mass system that may provide enhanced acoustic isolation compared to single barrier configurations. In this system, acoustic energy must traverse the first barrier, propagate through the intermediate air space, and then encounter the second barrier before transmission is complete. The air gap between the barriers functions as a spring element that decouples the vibrational motion of the two barriers, allowing each to respond independently to acoustic excitation rather than transmitting energy directly from one barrier to the other. This decoupling effect results in improved sound transmission loss characteristics, particularly at frequencies above the system's mass-air-mass resonance frequency, where the acoustic isolation benefits of the double wall configuration become more pronounced compared to equivalent single wall constructions of similar total mass.

The mass-air-mass system can be analyzed as two facings with surface masses m₁ and m₂ (kg/m²) connected by discrete coupling points of dynamic stiffness kₚ(N/m) each, spaced on a grid with spacing s (m). The number of couplings per unit area is defined as N=1/s², while the total coupling stiffness per unit area becomes k_tot=N·kₚ.

The mass-spring-mass resonance frequency of the double wall system occurs at f₀=(1/2π)√(k_tot/m_eff), where the effective mass is m_eff=(m₁·m₂)/(m₁+m₂). Increasing the coupling density N through closer spacing raises k_tot, shifting f₀ upward, while decreasing N through wider spacing lowers k_tot, shifting f0 downward. For frequencies well above f₀, the sound transmission loss approximates TL(ω)≈20 log₁₀(ω²·m₁·m₂/k_tot), where ω=2πf. This relationship demonstrates that doubling k_tot through halving spacing s reduces transmission loss by approximately 6 dB across mid-high frequencies, while halving k_tot through doubling spacing s increases transmission loss by approximately 6 dB. The enhanced structural properties of the thicker door facing hollow core doors described herein enable wider spacing of internal coupling points, thereby reducing k_tot and improving acoustic performance through the mathematical relationships governing the double wall phenomenon.

The internal cavity 116 described above can incorporate absorptive material positioned strategically within the hollow core areas to enhance acoustic performance and reduce resonance effects that may otherwise compromise sound transmission characteristics. The absorptive material can be fabricated from fiberglass, which provides effective sound absorption through its fibrous structure that converts acoustic energy into thermal energy through viscous friction. Cotton batting represents another material option for the absorptive material, offering natural fiber characteristics that provide acoustic dampening while maintaining environmental compatibility. Mineral wool can also be used as the absorptive material, providing enhanced fire resistance properties along with acoustic absorption capabilities through its dense fibrous matrix. Viscoelastic open cell foam represents a fourth material option for the absorptive material, offering controlled acoustic dampening characteristics through its cellular structure that dissipates sound energy through both viscous and thermal mechanisms.

The placement configurations of the absorptive material within the internal cavity 116 can be tailored to maximize acoustic benefits while accommodating the structural requirements of the hollow core door assembly 100. In some cases, the absorptive material can be placed in plural recesses of the first door facing 112 and second door facing within the internal cavity 116, allowing the material to conform to the contoured surfaces created by panel configurations and raised or recessed regions. The absorptive material placement can be coordinated with the positioning of the internal sticks 126 and the core inserts 128 to create comprehensive acoustic treatment throughout the internal cavity 116. The absorptive material can be positioned in strips, patches, or continuous sheets depending on the specific acoustic requirements and the available space within each compartment of the internal cavity 116. The thickness and density of the absorptive material can be selected based on the target frequency ranges for acoustic treatment and the available depth within the hollow core areas.

The absorptive material functions in conjunction with the double wall phenomenon to improve sound transmission loss by addressing specific acoustic challenges that may occur in hollow core configurations. The double wall phenomenon creates a mass-air-mass acoustic barrier where sound energy encounters the first door facing 112, travels through the air space of the internal cavity 116, and encounters the second door facing before transmission through the hollow core door assembly 100. The absorptive material positioned within the internal cavity 116 dampens standing wave patterns that may develop between opposing door facings, reducing resonance effects that could otherwise create dips in acoustic performance at specific frequencies. The absorptive material also reduces sound wave reflections within the internal cavity 116, preventing acoustic energy from building up through constructive interference patterns that could compromise the effectiveness of the mass-air-mass barrier.

The acoustic enhancement achieved through the absorptive material integration addresses the resonance dip phenomenon that may occur in double wall systems around the 250-315 Hz frequency range. The absorptive material dissipates acoustic energy within the internal cavity 116 through multiple mechanisms, including viscous losses as air moves through the material structure and thermal losses as acoustic energy converts to heat through molecular friction. The strategic placement of the absorptive material within the plural recesses of the door facings ensures that sound waves entering the internal cavity 116 encounter dampening materials regardless of their angle of incidence or reflection patterns. The absorptive material works synergistically with the increased mass characteristics of thicker door facings (as will be discussed further below) and the optimized spacing of internal support elements to create a comprehensive acoustic system that maintains the benefits of the double wall phenomenon while minimizing the negative effects of cavity resonances that could otherwise reduce sound transmission class ratings.

As shown in FIGS. 1A and 1B, internal sticks 126 can be positioned within the internal cavity 116 to provide structural support and dimensional stability between opposing door facings. The internal sticks 126 can be arranged in various configurations, including longitudinal placement parallel to the door height and/or transverse arrangements across the door width, depending on the specific structural requirements and panel configuration of the hollow core door assembly 100. In some cases, the internal sticks 126 can be strategically positioned to align with panel boundaries or other structural features of the door facings to provide targeted support where load concentrations may occur during normal door operation.

The internal sticks 126 can serve multiple functions within the hollow core door assembly 100, including preventing facing deflection under load, maintaining proper spacing between door facings, and contributing to the overall structural integrity of the door, while also preserving the hollow core characteristics that enable acoustic optimization. The placement and spacing of the internal sticks 126 can be coordinated with other internal support elements to create a comprehensive support network that distributes loads effectively throughout the door structure, as further discussed below. In some aspects, the internal sticks 126 can also contribute to the acoustic performance of the door by providing controlled interruptions to the internal cavity 116 that can influence sound wave propagation patterns.

The internal sticks 126 can be fabricated from various materials selected to balance structural performance with acoustic considerations and manufacturing requirements. Suitable materials may include viscoelastic foam, which can provide both structural support and acoustic dampening properties, paperboard for lightweight applications, wood for enhanced structural strength, expanded polystyrene (EPS) foam for weight reduction, cork for acoustic dampening characteristics, rigid fiber board for dimensional stability, or combinations of these materials. The material selection for the internal sticks 126 can be tailored based on the specific performance requirements of the hollow core door assembly 100, including desired acoustic ratings, structural load requirements, and manufacturing considerations.

As shown in FIG. 1B, multiple core inserts 128 can also be incorporated within the internal cavity 116 to provide additional structural support and dimensional stability. The core inserts 128 can be constructed from corrugated paper or expanded polystyrene (EPS), with these materials offering lightweight characteristics while providing adequate structural support for the hollow core door assembly 100. The core insert 128 can be dimensioned to span the distance between opposing door facings, creating a bridge-like support structure that prevents facing deflection under load. In some cases, the core inserts 128 can be secured to the door facings using adhesive or other securing mechanisms applied to either side of the core inserts 128, creating a mechanical bond that transfers loads between the core inserts 128 and the surrounding door structure. The placement of the core inserts 128 within the internal cavity 116 can be configured to align with raised regions or recessed areas of the door facings, accommodating the contoured surfaces while maintaining structural continuity.

The core insert 128 placement can be coordinated with the internal sticks 126 to create a comprehensive support network that distributes loads effectively while maintaining the hollow core characteristics that enable acoustic optimization. The integration of these internal support components within the internal cavity 116 creates a structural system that leverages the enhanced stiffness of thicker door facings to achieve superior performance with reduced material usage compared to conventional hollow core door designs.

The exterior surfaces of the first door facing 112 and the second door facing can be planar (flush), or they can include transition regions or contoured regions surrounding panels that are coplanar with or recessed from the main body area of the door facings. In some cases, the door facing exterior surfaces can be smooth, textured (e.g., to provide the appearance of woodgrain and optionally wood background tones), or a combination of the two. These surface characteristics can be achieved through molding processes during manufacturing or through post-manufacturing treatments applied to the door facing surfaces. The structural arrangement of the peripheral frame 114 components supports these various surface configurations while maintaining the integrity of the internal cavity 116 that enables the acoustic performance benefits of the hollow core door assembly 100, as further explained below.

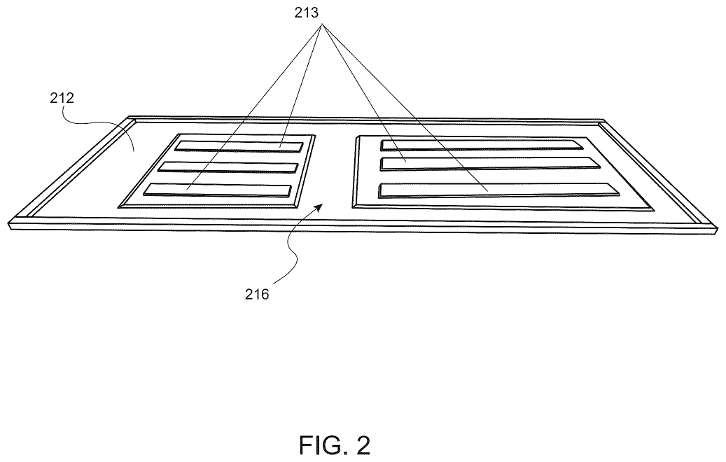

Referring now to FIG. 2, a hollow core door 200 demonstrates an exemplary structural configuration that enables enhanced acoustic performance through optimized door facing specifications. A door facing 212 in this configuration is shown to have a thickness between about 0.150 to 0.320 inches, which represents a substantial increase compared to standard hollow core door constructions, which generally have 0.125″ facings. This door facing 212 can have a nominal density of between about 0.80 and 1.1 grams per cubic centimeter, providing the mass characteristics that contribute to improved sound transmission loss properties. This thickness range allows the door facing 212 to achieve enhanced structural stiffness while maintaining the hollow core design that enables the double wall phenomenon. The increased thickness of the door facing 212 creates a more substantial barrier to sound transmission while allowing for reduced internal support requirements due to the enhanced structural properties of the thicker facing material.

The door facing 212 shown in FIG. 2 can be constructed from various materials that provide the density and structural characteristics needed for acoustic performance. Wood composite materials such as hardboard, medium density fiberboard (MDF), and oriented strand board, for example, can be formed to the specified thickness and density parameters. Sheet molding compounds (SMCs) containing thermosetting polymer and fiberglass, for example, can also be used to create the door facing 212 with the desired mass and structural properties. Fiberglass-reinforced thermoplastic materials offer yet another option for achieving the specified thickness and density characteristics while also providing durability and dimensional stability. Steel facings can also be employed where higher density and enhanced acoustic performance are desired, though the material selection can depend on the specific application requirements and manufacturing considerations.

The mass characteristics of the door facing 212 contribute directly to the acoustic performance of the hollow core door 200. In some cases, the door facing 212 can have 25% to 110% more mass than standard hollow core door facings, which translates to improved sound transmission class ratings. As further discussed below, the increased mass of the door facing 212 enhances the effectiveness of the mass-air-mass acoustic barrier created by the hollow core configuration. When the door facing 212 incorporates the specified thickness and density parameters, the overall door slab can have 17% to 125% more mass than a standard hollow core door slab while still maintaining weight advantages compared to solid core alternatives. This mass increase occurs primarily in the door facing 212 components rather than through the addition of solid core materials, allowing the hollow core area 216 to remain available for acoustic optimization.

With continued reference to FIG. 2, the hollow core area 216 demonstrates how the increased thickness and mass of the door facing 212 enables structural configurations that enhance acoustic performance. The hollow core area 216 in this example extends between opposing door facings and provides the air space component of the mass-air-mass acoustic system. The enhanced structural properties of the thicker door facing 212 allow for larger hollow core area 216 regions with fewer internal support elements, maximizing the acoustic benefits of the double wall phenomenon. Cork pucks 213 are positioned strategically within the hollow core door 200 to provide necessary structural connections between opposing door facings while minimizing interference with the acoustic properties of the hollow core area 216. The spacing and placement of the cork pucks 213 can be optimized based on the structural capabilities provided by the increased thickness of the door facing 212.

Double facing arrangements can be implemented where the door facing 212 comprises multiple layers adhered or secured together on either side of the peripheral frame 114. In such configurations, two separate facing layers can be bonded using adhesive or mechanical fasteners to create a composite door facing 212 with enhanced thickness and mass properties. The double facing arrangement allows for precise control of the overall thickness and mass characteristics, while allowing for incorporation of different materials in each layer to optimize specific performance attributes. The structural performance of double facing configurations benefits from the increased moment of inertia provided by the greater thickness, which reduces deflection under load and allows for wider spacing of internal support elements. This relationship between facing thickness and structural performance enables the hollow core door 200 to maintain dimensional stability while maximizing the hollow core area 216 available for acoustic optimization.

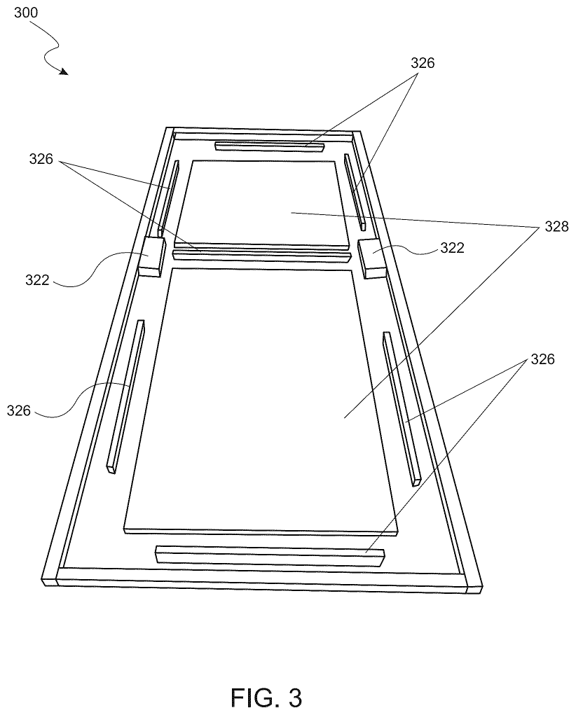

Referring now to FIG. 3, a hollow core door 300 is shown. This hollow core door 300 demonstrates the implementation of internal support components that maintain structural integrity while optimizing acoustic performance. In this example, internal sticks 326 are positioned within the internal cavity of the hollow core door 300 and collectively provide directional stability and load distribution between opposing door facings. Placement of the internal sticks 326 can be configured to align with panel boundaries (as shown in FIG. 3) or with one or more other structural features of the door facings to provide support where load concentrations may occur during normal door operation. Indeed, longitudinal placement of the internal sticks 326 can provide support parallel to the door height, while transverse arrangements can offer stability across the door width.

As noted above with reference to FIGS. 1A and 1B, the material selection for the internal sticks 326 can be tailored to balance structural performance with acoustic considerations. Viscoelastic foam, for example, can provide both structural support and acoustic dampening properties. Other suitable materials such as paperboard, wood, expanded polystyrene (EPS) foam, cork, rigid fiber board, etc. can also be used to fabricate the internal sticks 326.

The hollow core door 300 also includes lock blocks 322 strategically positioned within the peripheral frame structure to provide reinforced mounting points for door hardware such as handles, locks, hinges, and other components, similar to the lock blocks 122 described with respect to FIGS. 1A and 1B. The lock blocks 322 can be located adjacent to the door's stiles where hardware attachment can occur, ensuring secure installation while maintaining the hollow core configuration that enables acoustic optimization.

The hollow core door 300 shown in FIG. 3 also incorporates oriented strand board spacers 328 that function as higher density support elements within the door's internal cavity. The oriented strand board spacers 328 can replace the cork pucks 213 shown in FIG. 2, providing enhanced structural support through increased material density and stiffness characteristics. In some cases, the oriented strand board spacers 328 can be substituted with other higher density materials such as solid wood, engineered wood, or high density plastic components, to name a few, depending on the specific performance requirements and manufacturing considerations. The oriented strand board spacers 328 can be positioned at strategic locations within the internal cavity of the hollow core door 300 to provide point connections between opposing door facings while minimizing interference with the door's hollow core area that enables the double wall phenomenon. The spacing and distribution of the oriented strand board spacers 328 can be optimized based on the structural capabilities provided by the increased thickness of the door facing.

The relationship between increased facing stiffness and internal support requirements demonstrates how the enhanced structural properties of thicker door facings enable optimized internal component configurations. As noted above, an increased thickness of the door facing, ranging from about 0.150 to 0.320 inches, provides enhanced bending resistance that reduces the deflection characteristics of the facing material under applied loads. This enhanced stiffness allows for wider spacing between the internal sticks 326 and the oriented strand board spacers 328, reducing the total number of internal support elements needed while maintaining structural integrity of the hollow core door 300. The reduced internal support requirements create larger uninterrupted hollow core areas that enhance the acoustic performance through improved implementation of the double wall phenomenon. The structural efficiency gained through increased facing stiffness enables the hollow core door 300 to achieve comparable or superior structural performance compared to configurations with thinner facings and more numerous internal support elements.

The structural efficiency achieved through increased facing stiffness in the hollow core door 300 enables optimized spacing of internal support elements that directly correlates with acoustic performance improvements. The relationship between facing thickness and allowable support spacing follows the second moment of area principle, where deflection resistance scales with the cube of thickness (1=bh³/12). This relationship enables a facing thickness increase from 0.15 inches to 0.20 inches to support the same load with equivalent deflection when support spacing increases from 12 inches to 18 inches, representing a 50% increase in spacing capability.

The acoustic benefits of increased support spacing manifest through reduced mechanical coupling between opposing door facings. Each mechanical coupling point allows vibrational energy to transfer directly from one facing to the other, bypassing the air gap and any absorptive insulation within the door's internal cavity. Reducing the coupling density through wider spacing enables each facing to vibrate more independently, maximizing the effectiveness of the mass-air-mass barrier system. The mathematical relationship governing this phenomenon demonstrates that doubling the spacing between coupling points can increase sound transmission loss by approximately 6 dB across mid-range to high frequencies, while halving the spacing reduces transmission loss by the same magnitude.

The hollow core door 300 in this example leverages this relationship by utilizing thicker facings that provide enhanced structural stiffness, enabling wider spacing of internal support elements while maintaining structural integrity. This optimization allows the hollow core door 300 to achieve superior acoustic performance through both increased facing mass and reduced mechanical coupling density, creating a synergistic effect that enhances the double wall phenomenon beyond what would be achieved through either factor alone.

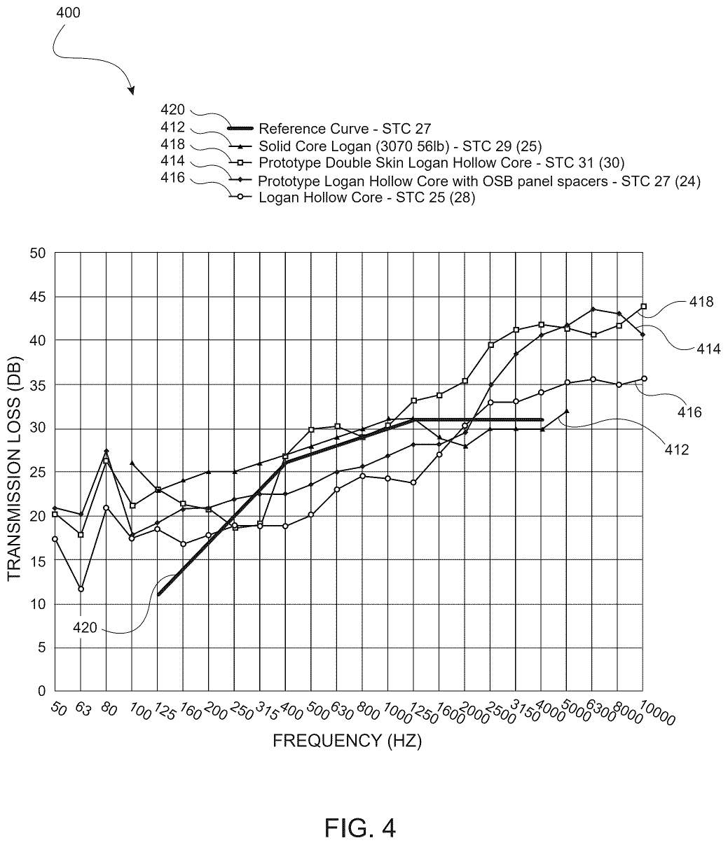

Referring to FIG. 4, a first Sound Transmission Class (“STC”) Graph 400 demonstrates acoustic transmission loss performance characteristics for multiple hollow core door configurations compared to solid core door baselines. A solid core transmission loss curve 412 provides baseline performance data for a solid core door weighing 56 pounds with an STC rating of 29, establishing the comparative standard for acoustic performance in traditional door construction. A standard hollow core transmission loss curve 416 shows the acoustic characteristics of a conventional hollow core door configuration, achieving an STC rating of 25 with significantly reduced weight compared to the solid core alternative. The standard hollow core transmission loss curve 416 demonstrates the acoustic limitations that have historically made hollow core doors unsuitable for applications requiring sound transmission control.

The STC Graph 400 also includes a double skin transmission loss curve 418 that illustrates the acoustic performance achieved through the implementation of increased facing thickness in hollow core door construction. The double skin transmission loss curve 418 demonstrates an STC rating of 31, representing a substantial improvement over the standard hollow core transmission loss curve 416 and exceeding the performance of the solid core transmission loss curve 412. This performance enhancement occurs despite the double skin configuration maintaining lower overall weight compared to the solid core door, demonstrating the effectiveness of the mass-air-mass acoustic system enabled by the hollow core design. An OSB panel transmission loss curve 414 shows the acoustic characteristics of a hollow core door incorporating oriented strand board spacers 328, achieving an STC rating of 27 through the addition of higher density internal support elements. A reference curve 420 provides an STC 30 baseline for comparative analysis across the frequency spectrum tested.

The acoustic transmission loss data presented in the STC Graph 400 reveals performance characteristics across frequency ranges from approximately 50 Hz to 10,000 Hz, with transmission loss values measured in decibels. The double skin transmission loss curve 418 demonstrates enhanced performance in mid-frequency ranges where the double wall phenomenon provides acoustic benefits through the mass-air-mass barrier effect. The solid core transmission loss curve 412 shows relatively consistent performance across frequency ranges, with acoustic benefits derived primarily from the increased mass of the solid core material. The OSB panel transmission loss curve 414 exhibits intermediate performance characteristics, with the higher density oriented strand board spacers 328 providing acoustic benefits through increased internal mass while maintaining the hollow core configuration. The standard hollow core transmission loss curve 416 demonstrates the acoustic limitations of conventional hollow core construction, particularly in frequency ranges where sound transmission control may be needed for residential or commercial applications.

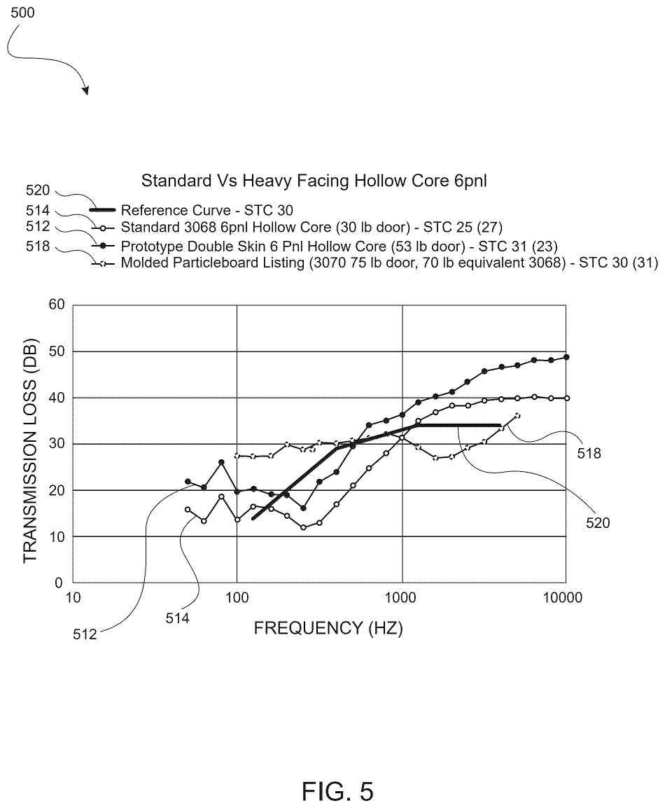

With reference to FIG. 5, a second STC Graph 500 provides detailed acoustic transmission loss analysis for door configurations that demonstrate the relationship between facing thickness and acoustic performance. A double skin transmission loss curve 512 shows the acoustic characteristics of a hollow core door with double facing construction, achieving an STC rating of 31 with a door weight of 53 pounds. A standard hollow core transmission loss curve 514 represents the baseline performance of a conventional hollow core door with standard facing thickness, achieving an STC rating of 25 with a door weight of 30 pounds. The comparison between the double skin transmission loss curve 512 and the standard hollow core transmission loss curve 514 demonstrates that the increased facing mass achieved through double skin construction provides substantial acoustic benefits while maintaining weight advantages compared to solid core alternatives.

The STC Graph 500 also includes a solid core transmission loss curve 518 that provides comparative data for a solid particleboard core molded door, establishing the performance characteristics of conventional solid core construction. A reference curve 520 provides an STC 30 baseline for performance evaluation across the tested frequency spectrum. The acoustic transmission loss data demonstrates that the double skin transmission loss curve 512 exceeds the performance of both the standard hollow core transmission loss curve 514 and approaches the performance levels of the solid core transmission loss curve 518. The double skin configuration achieves this performance enhancement through increased facing mass rather than solid core material, enabling the hollow core design to maintain the acoustic benefits of the mass-air-mass barrier system while providing enhanced sound transmission loss characteristics.

The frequency response characteristics shown in the STC Graph 500 reveal the acoustic behavior of each door configuration across the tested spectrum. The double skin transmission loss curve 512 demonstrates enhanced performance in higher frequency ranges where the increased facing mass provides greater acoustic impedance to sound transmission. The standard hollow core transmission loss curve 514 shows the acoustic limitations of conventional hollow core construction, with reduced transmission loss values across most frequency ranges compared to the enhanced configurations. The solid core transmission loss curve 518 exhibits performance characteristics that derive from the increased mass of the solid core material, providing acoustic benefits through mass-based sound transmission reduction rather than the mass-air-mass phenomenon utilized in hollow core designs.

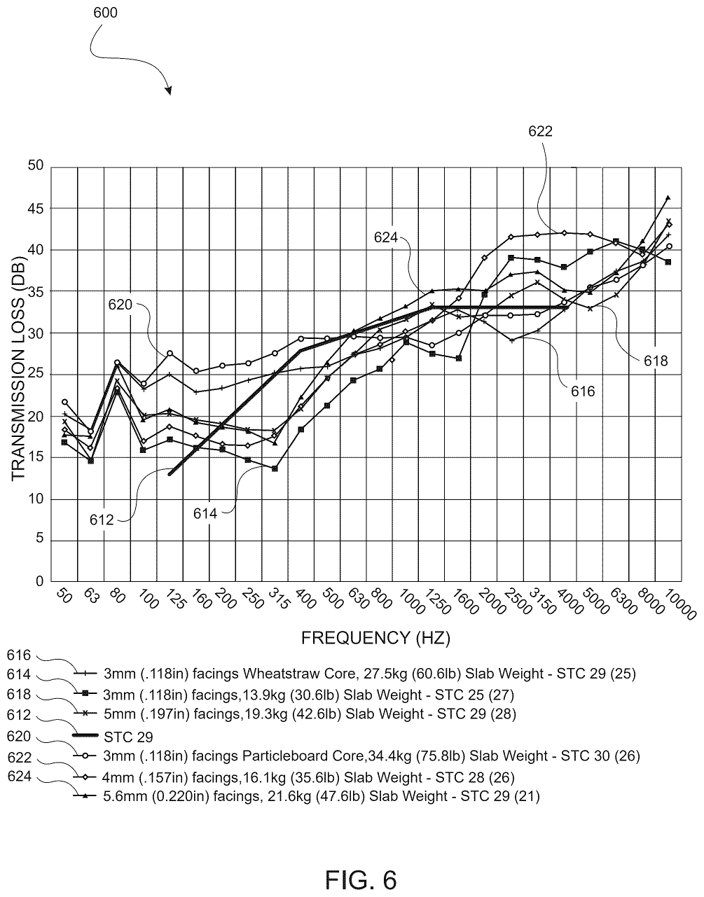

Referring now to FIG. 6, a third STC Graph 600 illustrates the relationship between facing thickness variations and acoustic performance across multiple door configurations with different overall weights. A reference curve 612 provides an STC 29 baseline for comparative analysis of the various door configurations tested. A first transmission loss curve 614 demonstrates the acoustic performance of a door with 3 mm facing thickness and a slab weight of 13.9 kg (30.6 pounds), achieving an STC rating of 27. A second transmission loss curve 622 shows the performance characteristics of a door with 4 mm facing thickness and a slab weight of 16.1 kg (35.6 pounds), achieving an STC rating of 28. A third transmission loss curve 624 represents a door configuration with 5.6 mm facing thickness and a slab weight of 21.6 kg (47.6 pounds), achieving an STC rating of 29.

The STC Graph 600 also includes comparative data for solid core door configurations to establish performance baselines for the hollow core door variations. A fourth transmission loss curve 616 shows the acoustic characteristics of a door with 3 mm facings over a wheatstraw core at 27.5 kg (60.6 pounds) slab weight, achieving an STC rating of 29. A fifth transmission loss curve 620 demonstrates the performance of a door with 3 mm facings over a particleboard core at 34.4 kg (75.8 pounds) slab weight, achieving an STC rating of 30. These solid core configurations provide comparative data that demonstrates the weight and cost advantages of the hollow core door designs while maintaining comparable acoustic performance characteristics.

The acoustic performance data presented in the STC Graph 600 demonstrates a direct correlation between facing thickness and sound transmission class ratings in hollow core door configurations. The progression from the first transmission loss curve 614 through the second transmission loss curve 622 to the third transmission loss curve 624 shows incremental improvements in STC ratings as facing thickness increases from 3 mm to 5.6 mm. The weight increases associated with thicker facings remain substantially lower than the weight penalties associated with solid core construction, as demonstrated by comparing the hollow core configurations to the fourth transmission loss curve 616 and the fifth transmission loss curve 620. Notably, the hollow core door configurations represented in the STC Graphs of FIGS. 4-6 achieve STC ratings between 25 and 31, with the higher ratings corresponding to increased facing thickness and optimized internal configurations that leverage the double wall phenomenon.

The frequency response characteristics across the STC Graph 600 configurations reveal how facing thickness affects acoustic performance in different frequency ranges. The third transmission loss curve 624, representing the thickest facing configuration, demonstrates enhanced transmission loss values in mid-frequency ranges where the increased facing mass provides greater acoustic impedance. The first transmission loss curve 614, representing the thinnest facing configuration, shows reduced transmission loss values across most frequency ranges, but maintains the hollow core weight advantages. The acoustic performance improvements achieved through increased facing thickness occur primarily in frequency ranges above the double wall resonance, where the enhanced mass characteristics of thicker facings provide greater sound transmission loss. The resonance dip phenomenon, occurring around 250-315 Hz in double wall systems, appears consistently across the hollow core configurations, with the depth and frequency characteristics of this dip influenced by the facing thickness and internal cavity dimensions of each door configuration tested.

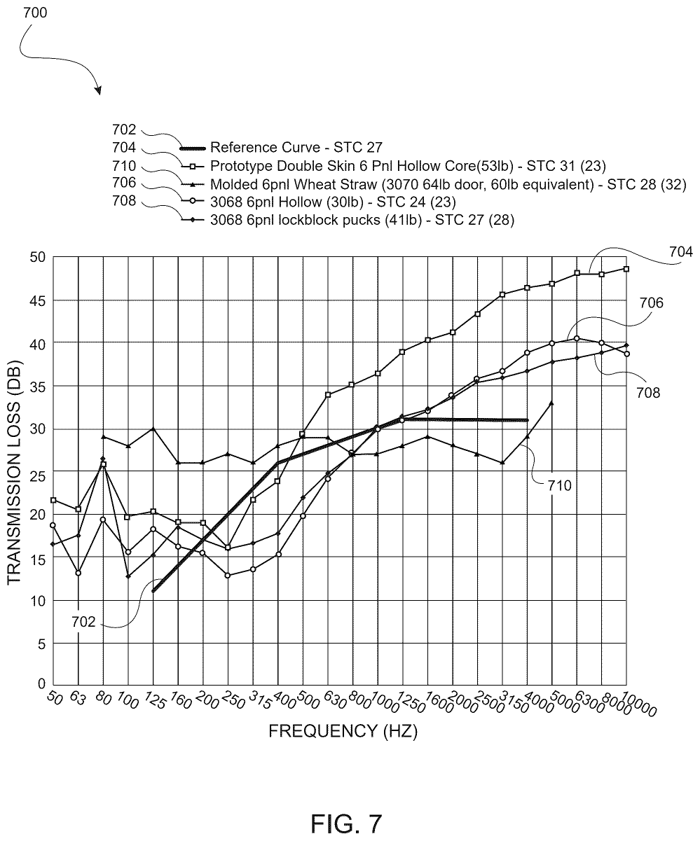

Referring to FIG. 7, a fourth STC Graph 700 demonstrates advanced acoustic transmission loss performance characteristics for multiple hollow core door configurations that incorporate various core materials and internal arrangements. A reference curve 702 provides baseline performance data for comparative analysis across the tested frequency spectrum. A transmission loss curve for a 6-panel hollow core door with a 0.25″-thick facing 704 illustrates the acoustic characteristics achieved through implementation of increased facing thickness in a six-panel door configuration, demonstrating enhanced sound transmission loss properties across mid-frequency ranges where the double wall phenomenon provides acoustic benefits. The thicker facing configuration represented by the 0.25″-thick facing transmission loss curve 704 achieves performance improvements through increased facing mass while maintaining the hollow core design that enables the mass-air-mass acoustic barrier system.

The STC Graph 700 also includes a transmission loss curve 706 for a standard 0.125″ facing 6-panel hollow core door with cardboard spacers that represents conventional hollow core door construction with standard internal support elements. A transmission loss curve 708 for a standard 0.125″ facing 6-panel hollow core door with a wheatstraw blocks is also shown, demonstratrating the acoustic performance achieved through the incorporation of wheatstraw block core materials as internal support elements, providing enhanced structural properties and acoustic characteristics compared to conventional cardboard spacer configurations. A transmission loss curve 710 for a standard 0.125″ facing 6-panel hollow core door with a wheatstraw core shows the acoustic behavior of a door configuration that utilizes wheatstraw core material throughout the internal cavity, creating a hybrid approach that combines hollow core design principles with enhanced internal mass distribution. The acoustic transmission loss data presented across these configurations reveals performance variations that correlate with the specific core material implementations and internal arrangement strategies employed in each door design.

The wheatstraw block implementation demonstrated in the transmission loss curve 708 represents an advanced core material configuration that provides enhanced acoustic performance through strategic placement of higher density internal elements. Wheatstraw blocks function as discrete support elements positioned within the internal cavity to provide structural connections between opposing door facings while contributing additional mass to the overall acoustic system. The wheatstraw material offers density characteristics that exceed conventional cardboard spacers while maintaining manufacturing compatibility with hollow core door production processes. The placement pattern of wheatstraw blocks can be optimized to provide structural support where load concentrations may occur during normal door operation while minimizing interference with the hollow core areas that enable the double wall phenomenon. The acoustic benefits achieved through wheatstraw block implementation occur through the combination of increased internal mass and maintained hollow core characteristics, allowing the door configuration to leverage both mass-based sound transmission reduction and the mass-air-mass barrier effect.

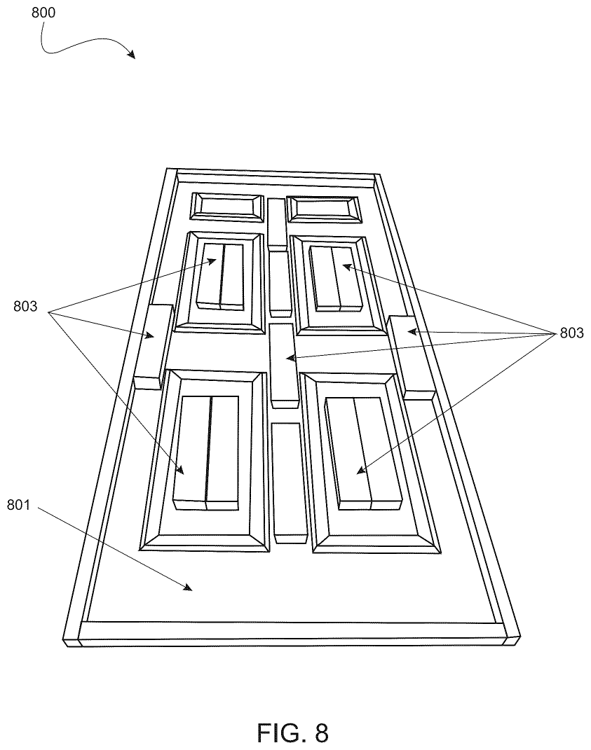

With reference to FIG. 8, a standard facing (0.125″) 6-panel hollow core door with wheatstraw blocks 800 is shown to demonstrate the physical implementation of wheatstraw block core material arrangements within a six-panel door configuration. A standard facing 801 provides the exterior surface characteristics typical of conventional hollow core door construction, with panel configurations and surface treatments that accommodate residential and commercial applications. Multiple wheatstraw blocks 803 are positioned strategically within the door structure to provide internal support and enhanced acoustic properties. The wheatstraw blocks 803 are arranged in a symmetrical pattern that aligns with the panel boundaries and structural features of the standard facing 801, creating a support network that distributes loads effectively while maintaining hollow core areas between the support elements. The wheatstraw blocks 803 can be secured to the standard facing 801 and the opposing door facing using adhesive or mechanical fastening methods that create structural continuity throughout the door assembly.

The wheatstraw blocks 803 shown in FIG. 8 provide enhanced density characteristics compared to conventional cardboard or expanded polystyrene support elements, contributing additional mass to the acoustic system while maintaining the hollow core configuration that enables the double wall phenomenon. The material properties of the wheatstraw blocks 803 include natural fiber composition that provides both structural strength and acoustic dampening characteristics through the fibrous matrix structure. The positioning of the wheatstraw blocks 803 within the door assembly creates discrete connection points between opposing door facings, allowing each facing to maintain independent vibrational characteristics while providing structural stability under load conditions. The spacing between the wheatstraw blocks 803 creates hollow core regions that function as air cavities within the mass-air-mass acoustic barrier system, enabling sound transmission loss through the double wall phenomenon while benefiting from the additional mass provided by the wheatstraw block elements.

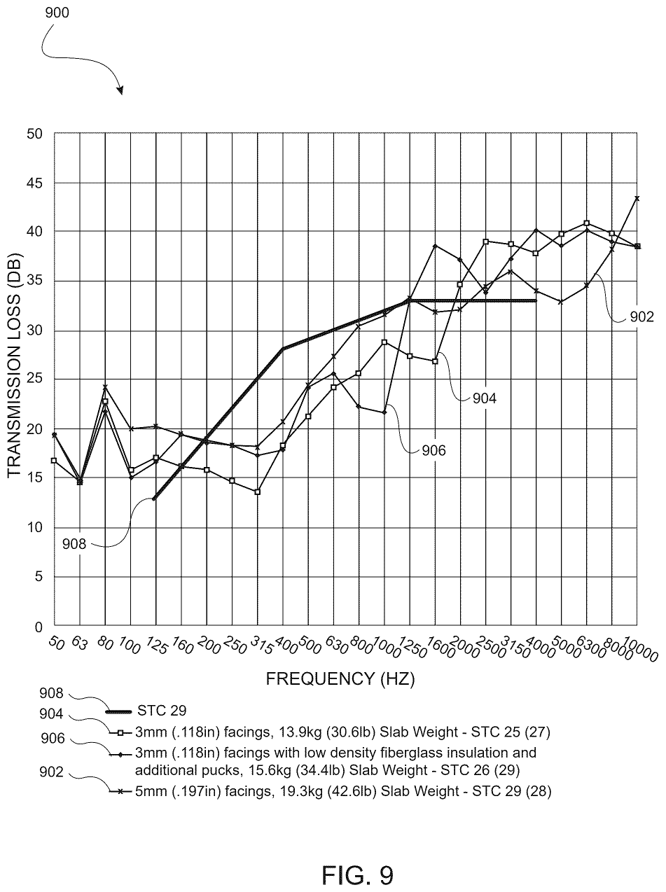

Referring now to FIG. 9, an fifth STC Graph 900 illustrates acoustic transmission loss performance characteristics for door configurations that incorporate fiberglass insulation arrangements and various facing thickness specifications. A reference curve 908 provides baseline performance data for comparative analysis across the tested frequency spectrum. A transmission loss curve 902 for a 5 mm thick facing hollow core door without insulation demonstrates the acoustic characteristics achieved through increased facing thickness in a two-panel door configuration, showing enhanced sound transmission loss properties that result from the increased mass and structural stiffness of the thicker facing material. This 2-panel door achieves performance improvements through facing mass enhancement while maintaining the hollow core design that enables the mass-air-mass acoustic barrier system without additional insulation materials.

The STC Graph 900 also includes a first transmission loss curve 904 that represents conventional 2-panel hollow core door construction with standard 0.125″ facing thickness and internal arrangements. A second transmission loss curve 906 for a standard 0.125″ facing 2-panel hollow core door having fiberglass insulation is also shown, and it demonstrates the acoustic performance achieved through the integration of fiberglass insulation materials within the internal cavity of this standard facing thickness door configuration. The comparison between the first transmission loss curve 904 (re: standard 0.125″ facing 2-panel hollow core door) and the second transmission loss curve 906 (re: standard 0.125″ facing 2-panel hollow core door with fiberglass insulation) reveals the acoustic benefits provided by fiberglass insulation implementation, particularly in frequency ranges where the insulation material provides dampening of cavity resonances that may otherwise reduce sound transmission class ratings. The fiberglass insulation configuration represented by the second transmission loss curve 906 addresses the resonance dip phenomenon that occurs around 250-315 Hz in double wall systems, providing acoustic energy dissipation that improves overall transmission loss characteristics.

The fiberglass insulation arrangements demonstrated in the second transmission loss curve 906 function through multiple acoustic mechanisms that enhance the performance of the hollow core door configuration. Fiberglass insulation materials provide sound absorption through their fibrous structure, which converts acoustic energy into thermal energy through viscous friction as sound waves interact with the fiber matrix. The placement of fiberglass insulation within the internal cavity creates acoustic dampening that reduces standing wave patterns between opposing door facings, minimizing resonance effects that could otherwise compromise the effectiveness of the mass-air-mass barrier system. The fiberglass insulation also reduces sound wave reflections within the internal cavity, preventing acoustic energy buildup through constructive interference patterns that could reduce transmission loss performance. The integration of fiberglass insulation with the hollow core design maintains the double wall phenomenon while providing additional acoustic treatment that addresses specific frequency ranges where cavity resonances may occur.

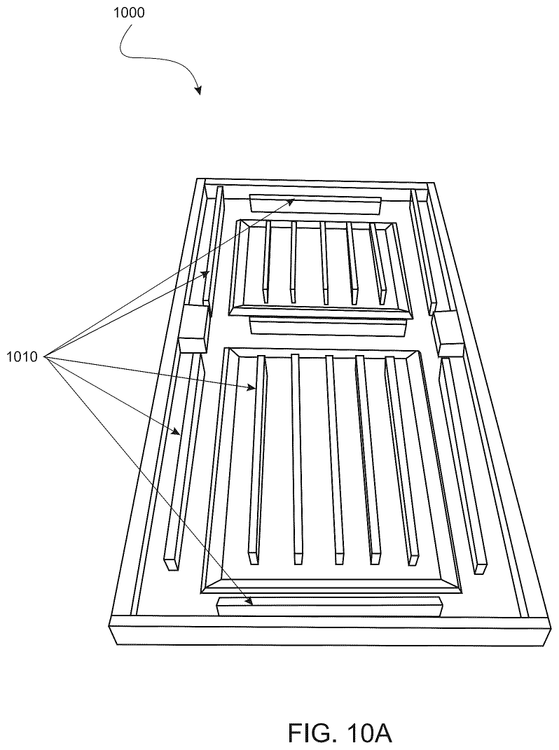

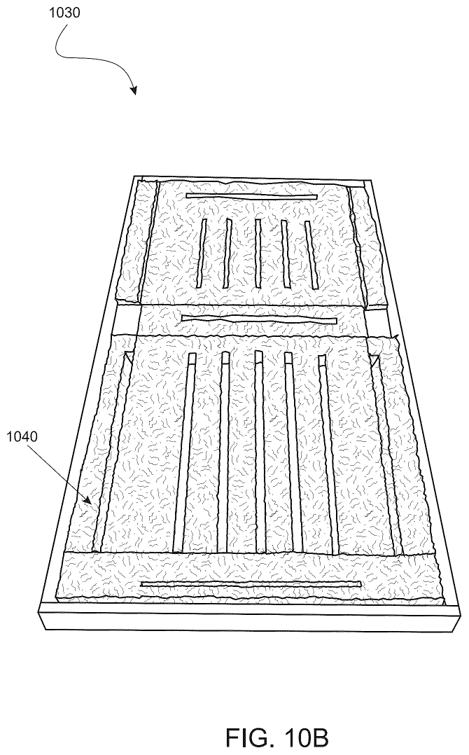

Turning now to FIG. 10A, a 2-panel hollow core door 1000 with internal sticks 1010 demonstrates an alternative internal support configuration that utilizes elongated support elements to provide structural stability while maintaining hollow core characteristics. Multiple internal sticks 1010 are positioned within the door structure in parallel arrangements that extend across the width or height of the door's internal cavity. The internal sticks 1010 provide directional support between opposing door facings while creating minimal interference with the hollow core areas that enable the double wall phenomenon. The elongated configuration of the internal sticks 1010 allows for efficient load distribution across the door structure while reducing the total number of discrete support elements needed compared to conventional puck-based support systems. The internal sticks 1010 can be fabricated from various materials as noted above, including paperboard, wood, expanded polystyrene foam, viscoelastic foam, cork, or rigid fiber board, with material selection based on the specific structural and acoustic requirements of the door application.

The internal sticks 1010 shown in FIG. 10A create a support network that accommodates the panel configuration of the door while providing structural continuity between opposing door facings. The parallel arrangement of the internal sticks 1010 allows for consistent spacing between support elements, creating uniform hollow core regions that function effectively within the mass-air-mass acoustic system. The elongated geometry of the internal sticks 1010 provides enhanced structural efficiency compared to discrete support elements, allowing for reduced material usage while maintaining adequate load-bearing capacity. The positioning of the internal sticks 1010 can be coordinated with the panel boundaries and structural features of the door facings to provide targeted support where load concentrations may occur during normal door operation. The acoustic performance of the 2-panel hollow core door with stick-shaped core inserts 1000 benefits from the reduced number of mechanical coupling points between opposing door facings, allowing each facing to maintain more independent vibrational characteristics that enhance the effectiveness of the double wall phenomenon.

Referring to FIG. 10B, a 2-panel hollow core door with insulation 1030 demonstrates the implementation of comprehensive insulation arrangements within a two-panel door configuration. Multiple strips of insulation 1040 are positioned within the internal cavity of the door structure, creating acoustic treatment throughout the hollow core areas. The insulation 1040 includes multiple parallel openings or slits configured to accommodate the internal sticks 1010 (as shown in FIG. 10A), allowing the insulation to be positioned around the internal support elements while maintaining continuous acoustic treatment. The insulation 1040 can be configured to extend across the width of the door and across its length, providing consistent acoustic dampening characteristics throughout the door's internal cavity. The insulation 1040 can be fabricated from fiberglass, cotton batting, mineral wool, viscoelastic open cell foam, or combinations of these materials, with material selection based on the specific acoustic performance requirements and manufacturing considerations. The placement pattern of the insulation 1040 can be coordinated with internal support elements, as shown in FIG. 10B, to create comprehensive acoustic treatment while maintaining the structural integrity of the door assembly.

The insulation 1040 shown in FIG. 10B functions to address cavity resonances and standing wave patterns that may develop within the hollow core areas of the door structure. Notably, the parallel openings in the insulation 1040 provide additional dampening characteristics by creating controlled acoustic pathways and reducing direct sound transmission through the internal support elements. The fibrous or cellular structure of the insulation 1040 provides acoustic energy dissipation through viscous losses as air moves through the material and thermal losses as acoustic energy converts to heat through molecular friction. The strategic placement of the insulation 1040 within the internal cavity, including its configuration around the internal sticks 1010, ensures that sound waves entering the hollow core areas encounter dampening materials regardless of their angle of incidence or reflection patterns. The insulation 1040 works in conjunction with the mass characteristics of the door facings and the air cavity dimensions to optimize the acoustic performance of the mass-air-mass barrier system. The acoustic benefits achieved through the insulation 1040 implementation can include reduced resonance dip effects around 250-315 Hz and enhanced transmission loss characteristics across frequency ranges where cavity resonances may otherwise compromise sound transmission class ratings. The 2-panel hollow core door with insulation 1030 demonstrates how comprehensive insulation arrangements can enhance the acoustic performance of hollow core door configurations while maintaining the weight and cost advantages compared to solid core alternatives.

As evident from the foregoing, the thicker-facing hollow core door configurations described herein provide significant advantages compared to traditional hollow core doors and solid core acoustic doors. For one, the hollow core door assemblies described herein provide improved STC ratings when compared to conventional hollow core doors, and comparable STC ratings when compared to solid core doors. For example, comparative analysis demonstrates that a standard hollow core door having 3 mm (approx 0.118″) facings can achieve an STC rating of 25, while hollow core doors with thicker facings of 4 mm (approx 0.157″), 5 mm (approx. 0.197″) or 5.6 mm (approx. 0.220″) thick provide improved STC ratings of STC 28, STC 29 and STC 29, respectively.

In addition, these thicker-facing hollow core doors provide comparable STC ratings when compared to solid core doors. For example, a solid wheatstraw core door requires 27.5 kg (60.6 pounds) to achieve an STC rating of 29, and a solid particleboard core door weighs 34.4 kg (75.8 pounds) to achieve an STC rating of 30. In sharp contrast, the 5.6 mm facing configuration discussed above achieves an STC rating of 29 at only 21.6 kg (47.6 pounds), representing a weight reduction of approximately 21% compared to the wheatstraw core door and 37% compared to the particleboard core door while maintaining comparable acoustic performance. Similarly, the 4 mm facing configuration weighs approx. 16.1 kg (35.6 pounds) to achieve its STC rating of 28, while the 5 mm facing configuration weighs approx. 19.3 kg (42.6 pounds) for an STC rating of 29. These configurations also achieve acoustic performance comparable to the solid core doors alternatives mentioned above, while maintaining weight advantages of approx. 30% to 53%, depending on the specific configuration and comparison baseline.

In addition to achieving comparable acoustic performance with reduced weight characteristics, the hollow core door configurations of this disclosure also improve manufacturing safety (e.g., by reducing the physical strain on workers during assembly, handling, and installation processes), reduce material costs, and improve manufacturing productivity (e.g., faster assembly times as workers can more easily manipulate and position door components during manufacturing). The safety benefits can extend to installation operations, where the door reduced weight enables easier handling, reduced risk of dropping, and lower likelihood of injuries associated with installation procedures.

The weight reduction achieved through the new hollow core door design also provides substantial transportation cost advantages throughout the distribution chain. The reduced weight characteristics enable higher door quantities per shipping container or truck load, maximizing transportation efficiency and reducing per-unit shipping costs. A typical shipment of hollow core doors may be able to accommodate 21% to 53% more units based on weight, as compared to equivalent solid core acoustic doors, depending on the specific configuration and comparison baseline. The transportation benefits can also extend to fuel consumption reduction and reduced shipping costs, as lighter loads require less energy for transport over equivalent distances.

In summary, the present disclosure provides an enhanced hollow core door construction that achieves superior acoustic performance through increased facing thickness and optimized internal configurations. The system offers advantages including improved STC ratings comparable to solid core doors, significant weight reduction of 21% to 53% compared to conventional solid core alternatives, reduced material costs, and enhanced manufacturing safety through easier handling and installation. The hollow core door assemblies leverage the double wall phenomenon through strategic placement of internal support elements and absorptive materials, enabling sound transmission class ratings between 25 and 31 while maintaining the structural integrity and cost-effectiveness associated with hollow core construction. These features collectively provide a comprehensive solution for residential and commercial applications requiring acoustic control without the weight penalties and material costs of traditional solid core doors.

A number of implementations have been described. Nevertheless, it will be understood that various modifications may be made without departing from the spirit and scope of the disclosure. Accordingly, other implementations are within the scope of the following claims.

1. An acoustic hollow core door, comprising:
a door slab including an inner door frame;
a first facing secured to a first side of the inner door frame; and
a second facing secured to a second, opposite side of the inner door frame,
wherein the inner door frame and the first and second facings define an at least partially hollow air cavity, and wherein at least one of the first facing or the second facing has a thickness between about 0.150 and 0.320 inches and a nominal density of between about 0.80 and 1.1 grams per cubic centimeter.

2. The acoustic hollow core door of claim 1, wherein both the first facing and the second facing have a thickness between about 0.150 and 0.320 inches and a nominal density of between about 0.80 and 1.1 grams per cubic centimeter.

3. The acoustic hollow core door of claim 1, wherein at least one of the first facing and the second facing comprises a double facing arrangement with multiple layers adhered together.

4. The acoustic hollow core door of claim 1, wherein the first facing and the second facing have 25% to 110% more mass than facings of a hollow core door having a facing thickness of about 0.125″.

5. The acoustic hollow core door of claim 1, wherein the first facing and the second facing are formed from materials selected from the group consisting of wood composite, hardboard, medium density fiberboard, oriented strand board, wood-plastic composites, sheet molding compounds containing thermosetting polymer and fiberglass, fiberglass-reinforced thermoplastic, steel, and combinations thereof.

6. The acoustic hollow core door of claim 1, wherein the door slab has 17% to 125% more mass than a door slab of a hollow core door having a facing thickness of about 0.125″.

7. The acoustic hollow core door of claim 1, further comprising one or more internal sticks or core inserts positioned within the hollow air cavity between the first and second facings.

8. The acoustic hollow core door of claim 7, wherein the one or more internal sticks or core inserts comprise materials selected from the group consisting of paperboard, wood, expanded polystyrene foam, viscoelastic foam, cork, rigid fiber board, corrugated paper, oriented strand board, wheatstraw blocks, and combinations thereof.

9. The acoustic hollow core door of claim 7, further comprising at least one acoustically absorptive material positioned within the hollow air cavity between the first and second facings.

10. The acoustic hollow core door of claim 9, wherein the acoustically absorptive material comprises materials selected from the group consisting of fiberglass, cotton batting, mineral wool, viscoelastic open cell foam, and combinations thereof.

11. The acoustic hollow core door of claim 9, wherein the acoustically absorptive material is positioned in plural recesses of the first and second facings within the hollow air cavity and is configured to reduce resonance effects around 250-315 Hz frequency range.

12. A method of manufacturing an acoustic hollow core door, comprising:
securing a first facing to a first side of an inner door frame;
securing one or more internal support elements within a hollow air cavity defined by the inner door frame; and
securing a second facing to a second, opposite side of the inner door frame,
wherein at least one of the first facing or the second facing has a thickness between about 0.150 and 0.320 inches and a nominal density of between about 0.80 and 1.1 grams per cubic centimeter to provide enhanced acoustic performance through a double wall phenomenon.

13. The method of claim 12, wherein both the first facing and the second facing have a thickness between about 0.150 and 0.320 inches and a nominal density of between about 0.80 and 1.1 grams per cubic centimeter.

14. The method of claim 12, wherein the one or more internal support elements comprise materials selected from the group consisting of paperboard, wood, expanded polystyrene foam, viscoelastic foam, cork, rigid fiber board, corrugated paper, oriented strand board, wheatstraw blocks, and combinations thereof.

15. The method of claim 12, further comprising a step of positioning at least one acoustically absorptive material within the hollow air cavity between the first and second facings.

16. The method of claim 15, wherein the acoustically absorptive material comprises materials selected from the group consisting of fiberglass, cotton batting, mineral wool, viscoelastic open cell foam, and combinations thereof.

17. The method of claim 15, wherein the step of positioning the acoustically absorptive material reduces resonance effects occurring in around the 250-315 Hz frequency range.

18. The method of claim 12, wherein the one or more internal support elements are spaced to reduce mechanical coupling between the first and second facings and enhance the double wall phenomenon.

19. The method of claim 12, wherein the internal support elements comprise one or more internal sticks or core inserts configured to enhanced structural stiffness provided by the thickness of at least one of the first facing or the second facing.

20. The method of claim 12, wherein the acoustic hollow core door achieves a STC rating between 25 and 31 while maintaining a weight reduction of 17% to 53% compared to at least one solid core doors with comparable acoustic performance.
